(19) United States
(12) Patent Application Publication
(10) Pub. No.: US 2008/0214083 A1
(43) Pub. Date: Sep. 4, 2008

(54) Alignment layer printing apparatus and method of printing using the same

(75) Inventors: Soon Sung Yoo, Gunpo-si (KR); Youngyoung Chang, Anyang-si (KR); Seunghee Nam, Suwon-si (KR); Namkook Kim, Suwon-so (KR)

Correspondence Address: MCKENNA LONG & ALDRIDGE LLP, 1900 K STREET, NW, WASHINGTON, DC, 20006, US

(73) Assignee: LG.PHILIPS SCD CO., LTD., Seoul (KR)

(21) Appl. No.: 12/005,626

(22) Filed: Dec. 28, 2007

(30) Foreign Application Priority Data
Feb. 27, 2007 (KR) 10-2007-0019469

(51) Int. Cl. H01J 9/20; B41L 3/02; B41F 7/02

(52) U.S. Cl. 445/24; 101/486; 101/217

(57) ABSTRACT

A method of manufacturing a liquid crystal display includes: loading an upper substrate or a lower substrate on a stage; positioning a printing roll on the loaded substrate; measuring the printing roll, the measurement being indicative of a size change of the printing roll; compensating the operation of the printing roll relative to the stage according to the measurement of the printing roll; supplying an alignment solution to the printing roll; driving the printing roll under the compensated operation to print the alignment solution onto the loaded substrate; attaching the upper substrate and the lower substrate; and forming a liquid crystal layer between the upper substrate and the lower substrate.

This application claims the benefit of Korean Patent Application No. 2007-0019469, filed on Feb. 27, 2007, which is hereby incorporated by reference as if fully set forth herein.

### BACKGROUND

1. Field of the Invention

This document relates to an alignment layer printing apparatus, and more particularly, to an alignment layer printing apparatus using a roll printing method and a method of printing.

2. Discussion of the Related Art

As interest in information displays and demand for portable information media increases, research and commercialization on light, thin film type flat panel display (FPD) devices replacing traditional Cathode Ray Tubes (CRT) type display devices is actively being conducted. In particular, a liquid crystal display (LCD) device displays an image using optical anisotropy of liquid crystals, and is actively being applied to notebooks, desktop monitors or the like because it has an excellent resolution, color rendering capability and picture quality.

Generally, an LCD device is a display device in which data signals according to image information are individually supplied to liquid crystal cells arranged in a matrix form. Light transmittance of the liquid crystal cells is controlled to display a desired image.

Hereinafter, a liquid crystal display device will be described with reference to FIG. 1.

FIG. 1 is an exploded perspective view schematically showing the structure of a general liquid crystal display device.

The liquid crystal display device includes a color filter substrate 1 formed at an upper part, an array substrate 4 formed at a lower part, and a liquid crystal layer 8 formed therebetween.

The color filter substrate 1 includes a color filter layer 2 having red (R), green (G), and blue (B) sub-color filters 2a, 2b and 2c, a black matrix 3 for dividing the sub-color filters 2a, 2b and 2c and blocking light transmission through the liquid crystal layer 8, and a transparent common electrode (not shown) for applying voltage to the liquid crystal layer 8.

In the horizontal electric field mode, the common electrode of this type may be formed on the array substrate 4.

The array substrate 4 includes gate lines 5 and data lines 6 which are arranged vertically and horizontally to cross each other and thin film transistors T as switching elements formed at respective crossings of the gate lines 5 and the data lines 6. The array substrate 4 includes also pixel electrodes (not shown) formed on the pixel regions 7 defined by the gate lines 5 and the data lines 6.

The pixel region P is a sub pixel corresponding to one of the sub color filters 2a, 2b and 2c of the color filter substrate 1, and a color image is obtained by a combination of three types of the sub color filters 2a, 2b and 2c of red, green and blue.

In addition, the color filter substrate 1 and the array substrate 4 are coated with an alignment layer (not shown) for aligning liquid crystal molecules of the liquid crystal layer 8.

The thus-configured liquid crystal display device is fabricated by a process of fabricating a color filter substrate 1 and an array substrate 4, respectively, a process of attaching the color filter substrate 1 and the array substrate 4, a process of forming a liquid crystal layer 8 between the two attached substrates, a process of repair, and a module process of fabricating a module of a liquid crystal display device by mounting a backlight or the like at the back and mounting a driving circuit.

The color filter substrate 1 and the array substrate 4, respectively, are fabricated through several mask processes. After the mask processes, a process of printing an alignment layer for aligning liquid crystal molecules on the two substrates in a given direction is performed prior to attaching the two substrates.

A variety of methods, including roll printing, spin coating, inject printing, etc., may be applied to the alignment layer printing process.

In an alignment layer printing apparatus employing a roll printing method among those methods, an alignment layer with a uniform thickness is coated on the substrates by using a method of rotating a plurality of rolls by engaging with each other.

FIG. 2 is a view for explaining the problem of an alignment layer printing apparatus in accordance with the related art, which illustrates the problem according to the surface state of a printing roll 10 in the roll printing method.

FIG. 2(a) is a view showing a printing roll in a normal condition, and FIG. 2(b) is a view showing a printing roll whose surface is swollen.

The printing roll 10 applies ink on a substrate while rotating in a given direction on the top of a movable stage on which the substrate is loaded.

The printing roll 10 is driven according to preset rotation velocity Vθ, travel velocity VL and printing pressure.

However, as the printing is continuously performed, ink 14 is adsorbed into a rubber plate 12 covering the surface of the printing roll 10 to make the rubber plate 12 swollen.

As the rubber plate 12 is swollen, the total radius of the printing roll 10 and the rubber plate 152 increases to r′, and hence the distance I to be moved by the printing roll 10 and the movement distance I′ of the surface of the swollen rubber plate 16 are different from each other, thereby giving rise to the phenomenon of pushing the rubber plate 16 on the substrate.

As a result, a print pattern formed on the substrate 16 is shifted or pressed, thus leading to the distortion of the print pattern.

### SUMMARY OF THE INVENTION

Accordingly, the present invention is directed to an alignment layer printing apparatus, method of printing and method of manufacturing a liquid crystal display that substantially obviates one or more of the problems due to limitations and disadvantages of the related art.

An advantage of the present invention is to provide an alignment layer printing apparatus, which can enhance the accuracy of a roll printing method by measuring a printing roll in real time.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, a method of manufacturing a liquid crystal display includes: loading an upper substrate or a lower substrate on a stage; positioning a printing roll on the loaded substrate; measuring the printing roll, the measurement being indicative of a size change of the printing roll; compensating the operation of the printing roll relative to the stage according to the measurement of the printing roll; supplying an alignment solution to the printing roll; driving the printing roll under the compensated operation to print the alignment solution onto the loaded substrate; attaching the upper substrate and the lower substrate; and forming a liquid crystal layer between the upper substrate and the lower substrate.

In another aspect of the present invention, a method of printing includes: loading a substrate on a stage; positioning a printing roll on the substrate; measuring the printing roll, the measurement being indicative of a size change of the printing roll; compensating the operation of the printing roll relative to the stage according to the measurement of the printing roll; supplying ink to the printing roll; and driving the printing roll under the compensated operation to print the ink onto the substrate.

In yet another aspect of the present invention, a printing apparatus for printing an alignment layer of a liquid crystal display includes: a stage for loading a substrate thereon; a printing roll positioned on the stage to transfer ink onto the substrate while rotating in one direction; a displacement sensor for measuring a surface thickness of the printing roll; and a controller for compensating the operation of the printing roll relative to the stage according to a value measured by the displacement sensor.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is an exploded perspective view schematically showing the structure of a general liquid crystal display device;

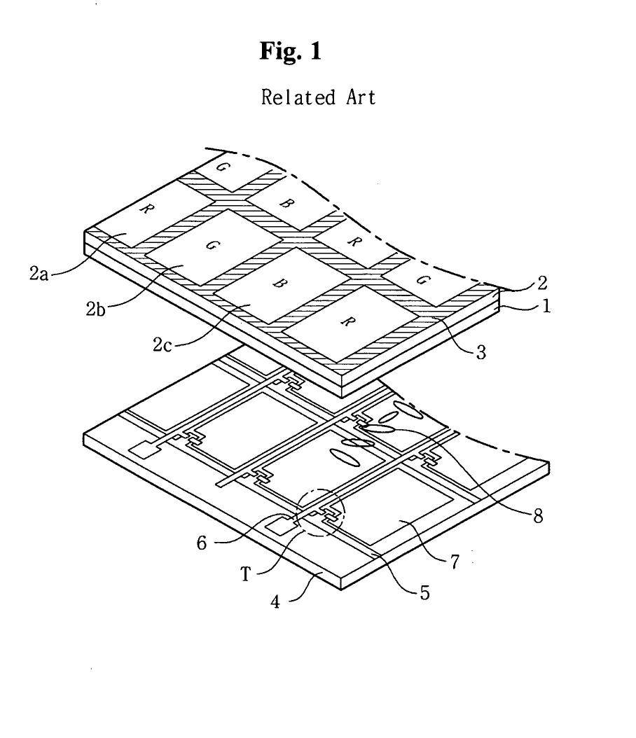

FIG. 2 is a view for explaining the problem of an alignment layer printing apparatus in accordance with the related art;

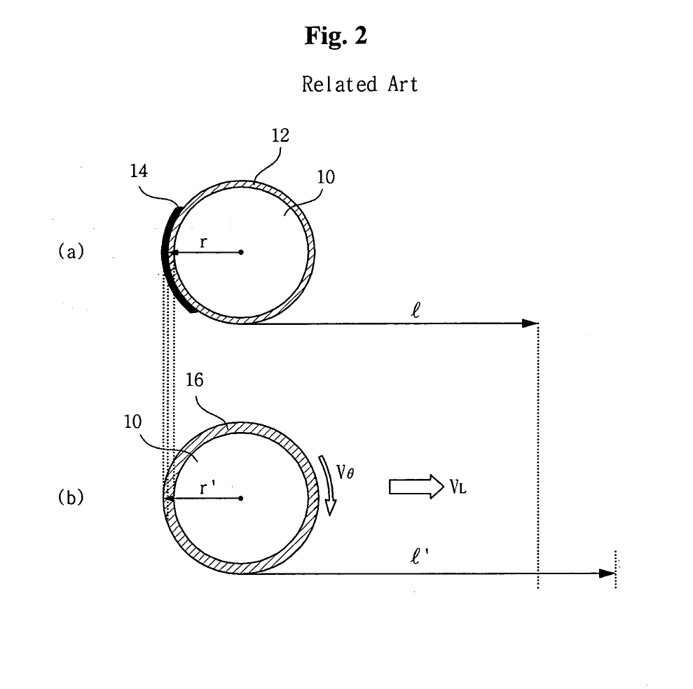

FIG. 3 is a configuration view showing an alignment layer printing apparatus in accordance with an embodiment of the present invention;

FIG. 4 is a view for explaining a driving system of the alignment layer printing apparatus in accordance with an embodiment of the present invention;

FIG. 5 is a view for explaining the driving principle of the alignment layer printing apparatus in accordance with an embodiment of the present invention; and

FIG. 6 is a flow chart for explaining a method of printing using the alignment layer printing apparatus in accordance with an embodiment of the present invention.

### DETAILED DESCRIPTION OF THE ILLUSTRATED EMBODIMENTS

Reference will now be made in detail to an embodiment of the present invention, example of which is illustrated in the accompanying drawings.

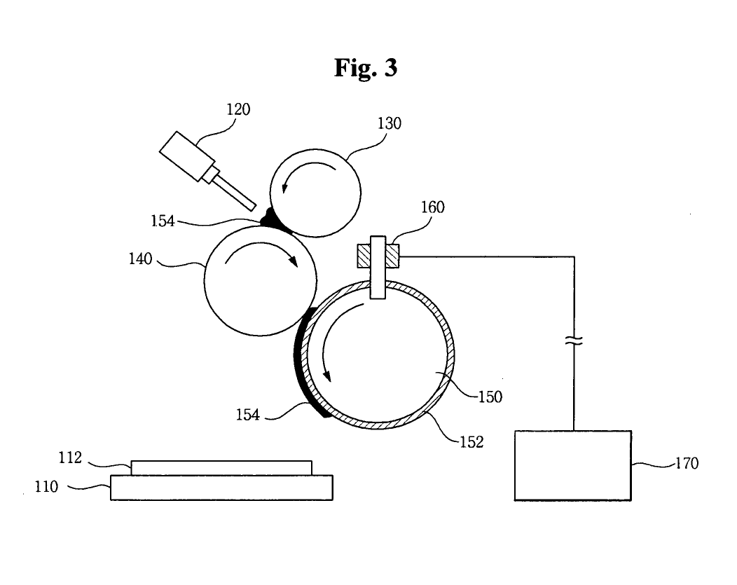

FIG. 3 is a configuration view showing an alignment layer printing apparatus in accordance with an embodiment of the present invention.

As shown in FIG. 3, the alignment layer printing apparatus in accordance with an embodiment of the present invention includes a movable stage 110 for loading a substrate 112 thereon, a dispenser 120, a doctor roll 130, an anilox roll 140, a printing roll 150, a displacement sensor 160, and a controller 170.

The stage 110 may be movable and have a resting space formed on the top surface for loading the substrate 112 thereon. The stage 110 may be freely movable in an up-and-down direction or left-and-right direction in the manufacturing process.

The doctor roll 130 rotates in engagement with the anilox roll 140, and the printing roll 150 rotates in engagement with the anilox roll 140.

The printing roll 150 includes an interior portion and a rubber plate 152 for transferring ink 154 provided on an outer surface of the interior portion.

By this configuration, the ink 154 supplied between the doctor roll 130 and the anilox roll 140 both having a cylindrical shape may be applied onto the surface of the anilox roll 140 by the doctor roll 130 rotating in engagement with the anilox roll 140, and at the same time, the printing roll 150 rotates in engagement with the anilox roll 140, so that the ink 154 on the surface of the anilox roll 140 may be transferred to the rubber plate 152.

The rubber plate 152 corresponds to the substrate 112 on which the ink 154 may be applied and has a mask pattern so that the ink 154 can be selectively printed on the substrate 112. Therefore, as the printing roll 150 rotates, the ink 154 transferred onto the rubber plate 152 may be selectively printed onto the substrate 112. The ink 154 may be supplied by means of a dispenser 120, such as an injector.

Here, the ink 154 may be an alignment solution for applying an alignment layer to be formed on a color filter substrate and an array substrate of a liquid crystal display device.

The printing roll may be measured. The measurement may be indicative of a size change of the printing roll. For example, the diameter, radius or circumference of the printing roll 150 including the rubber plate 152 may be measured and an thickness or expansion of the rubber plate 152 may be measured

In the embodiment of FIG. 3, the displacement sensor 160 may be placed outside the printing roll 150 and serves to measure the thickness the rubber plate 152 of the printing roll 150.

The displacement sensor 160 may be positioned above the printing roll 150 as shown in the drawing, and may also be positioned at a side portion or bottom portion of the printing roll 150 if the surface thickness of the printing roll 150 can be measured there. Herein, the surface thickness of the printing roll 150 means that the thickness of the rubber plate 152 formed on the printing roll 150. That is, the surface thickness of the printing roll 150 may be substantially the same as the thickness of the rubber plate 152. For the convenience of description, a structure where the displacement sensor 160 may be positioned above the printing roll 150 is illustrated and described.

The operation of the printing roll relative to the stage may be compensated according to the measurement of the printing roll. Compensating the operation of the printing roll relative to the stage may include compensating the operation of the printing roll and/or compensating the operation of the stage.

In the embodiment of FIG. 3, the controller 170 may calculate a change in the thickness of the rubber plate 152 based on a value measured by the displacement sensor 160, and compensate the operation of the printing roll 150 relative to the stage 110 according to the calculated change. In other embodiments, the controller 170 may otherwise compensate the operation of the printing roll relative to the stage 110 according to the measurement of the printing roll.

The operation of the printing roll 150 relative to the stage 110 may be compensated such that the mask pattern and thickness of ink to be printed onto the substrate is substantially uniform, and may include compensating a rotation velocity (angular velocity) at which the printing roll 150 is to rotate, a travel velocity at which the printing roll 150 is to move on the substrate 112 while rotating, an impression pressure of the printing roll 150, and so on.

The printing apparatus using a roll printing method employs a control for uniformly printing the ink 154 because a defect, such as a blur caused by non-uniform alignment may be generated on the screen of the liquid crystal display device due to a difference in the thickness of the ink 154 printed onto the substrate 112.

Hereinafter, a driving system for controlling the rotation velocity, travel velocity, and impression pressure of the printing roll 150 according to a change in the thickness of the printing roll 150 will be described in detail.

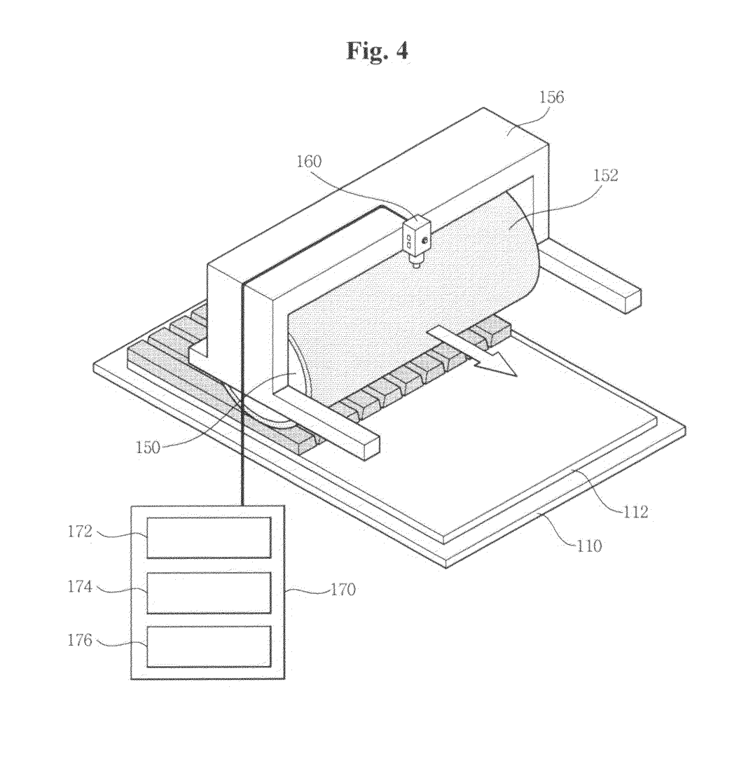

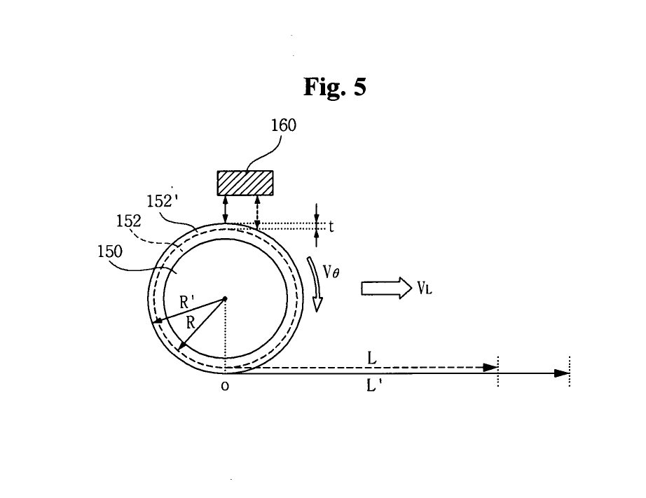

FIG. 4 is a view for explaining a driving system of the alignment layer printing apparatus in accordance with an embodiment of the present invention. FIG. 5 is a view for explaining the driving principle of the alignment layer printing apparatus in accordance with an embodiment of the present invention.

For reference, components performing the same function as those shown in FIGS. 4 and 5 are given the same numerals as those in FIG. 3.

First, referring to FIG. 4, in the alignment layer printing apparatus in accordance with the embodiment of the present invention, the printing roll 150 may be placed at a support 156 so as to be rotatable around a rotating shaft (not shown), and the displacement sensor 160 may be fixedly placed at the support 156 which may be above the printing roll 150. Further, the displacement sensor 160 may be electrically connected to the controller 170 located in the outside through wired and wireless communications.

The displacement sensor 160 may be a non-contact type, and calculates the surface thickness of the printing roll 150 by measuring the quantity of received light emitted onto the surface of the printing roll 150 or the time of light reception.

The displacement sensor 160 basically includes a light emitting unit for emitting light to the outside and a light receiving unit for receiving light from the light emitting unit, and may additionally include a light quantity level detector or a counter according to a sensing method.

The light quantity level detector measures the thickness of the rubber plate 152 by calculating a voltage level according to the quantity of light received by the light receiving unit, and the counter measures the thickness of the rubber plate 152 by a time difference by temporally counting a time point at which light is received by the light receiving unit.

Therefore, the displacement sensor 160 may be able to detect the thickness of the rubber plate 152 by the quantity of received light or by a time difference by emitting light onto the surface of the rubber plate 152 through the light emitting unit provided therein and receiving the light reflected from the surface of the rubber plate 152 through the light receiving unit.

The controller 170 includes a thickness converter 172 for converting the value measured by the displacement sensor 160 into a thickness value, a comparator 174 for comparing the existing thickness of the rubber plate 152 and the calculated thickness of the rubber plate 152 to calculate a change in thickness, and a compensator 176 for compensating for the operation of the printing roll 150 according to the change in thickness.

Here, the existing thickness of the rubber plate 152 is a thickness of the rubber plate 152 measured through the displacement sensor 160 in the previous step, and the operation of the printing roll 150 compensated for by the compensator 176 may include the travel velocity, rotation velocity, and impression pressure of the printing roll 150.

The compensation of the travel velocity, rotation velocity, and impression pressure of the printing roll 150 may be calculated using the principle as shown in FIG. 5.

Referring to FIG. 5, in a roll type printing apparatus, the rotation velocity (angular velocity) Vθ at which the printing rolls 150 may rotate and the travel velocity VL at which the printing roll 150 may move while rotating should match with each other so as to avoid the surface of the rubber plate 152 formed on the printing roll 150 from slippage on the substrate.

Namely, if the total radius of summing a radius of the rubber plate 152 and a radius of the printing roll 150 is R and the rotation velocity Vθ thereof is dθ, the velocity at the surface of the rubber plate 152 is dθR and the travel velocity VL at which the printing roll 150 moves should match the rotation velocity d OR.

However, if the total radius increases to R′ as the rubber plate 152 formed on the printing roll 150 is swollen by a thickness t, the rotation velocity and travel velocity of the printing roll 150 do not match with each other because the rotation velocity Vθ at which the surface of the swollen rubber plate 152 is to rotate is set to dθ(R+t) and the travel velocity at which the swollen rubber plate 152 is to move is set to dθR.

Therefore, the compensator (176 of FIG. 4) of the controller (170 of FIG. 4) compensates by a thickness change t calculated through the comparator (174 of FIG. 4) such that the travel velocity VL and rotation velocity Vθ of the printing roll 150 match with each other.

Such a compensation operation can be easily performed by an operational calculation method for compensating and substituting for preset parameters in the equation.

Meanwhile, the impression pressure of the printing roll 150 refers to a degree of a pressure that the ink transferred onto the substrate receives by the rotation force of the printing roll 150 while the printing roll 150 rotates, which may be varied according to the surface thickness of the printing roll 150.

That is, when it is assumed that, normally, the point where the printing roll 150 and the substrate meet each other is the starting point 0, if the rubber plate 152 formed on the printing roll 150 is swollen, the total radius of the printing roll 150 and the rubber plate 152 is changed. Accordingly, the starting point may also be changed.

For example, under the condition that an optimum impression pressure is 30□, if the rubber plate 152 is swollen to thus increase the total radius of the printing roll 150 and the rubber plate 152 by 20□, the impression pressure actually applied during the process becomes 50□, thus causing a printing defect.

Therefore, the compensator (176 of FIG. 4) of the controller (170 of FIG. 4) compensates for the starting point 0 of the printing roll 150 by a thickness change t calculated through the comparator (174 of FIG. 4), thus maintaining reproducibility and homoeostasis of the impression pressure of the printing roll 150. In FIG. 5, reference numeral 152′ represents a swollen rubber plate.

In the thus-configured alignment layer printing apparatus in accordance with the embodiment of the present invention, the thickness of rubber plate may be measured according to the light received from the surface of the printing roll 150 through the non-contact displacement sensor 160, the controller 170 compares the measured value with the existing thickness of the rubber plate 152, and then the travel velocity, rotation velocity, and impression pressure of the printing roll 150, respectively, are compensated for by a thickness change t.

Accordingly, by monitoring a thickness change of the rubber plate 152, it may be possible to prevent a print pattern defect and immediately process the operation of the printing roll 150 in response to a thickness change.

A method of printing is hereafter described in accordance with an embodiment of the present invention. A substrate may be loaded on a stage and a printing roll may be positioned on the substrate. A measurement of the printing roll may indicate a size change of the printing roll. The operation of the printing roll relative to the stage may be compensated according to the measurement of the printing roll. Ink may be supplied to the printing roll and the driving of the printing roll may occur under the compensated operation to print ink onto the substrate.

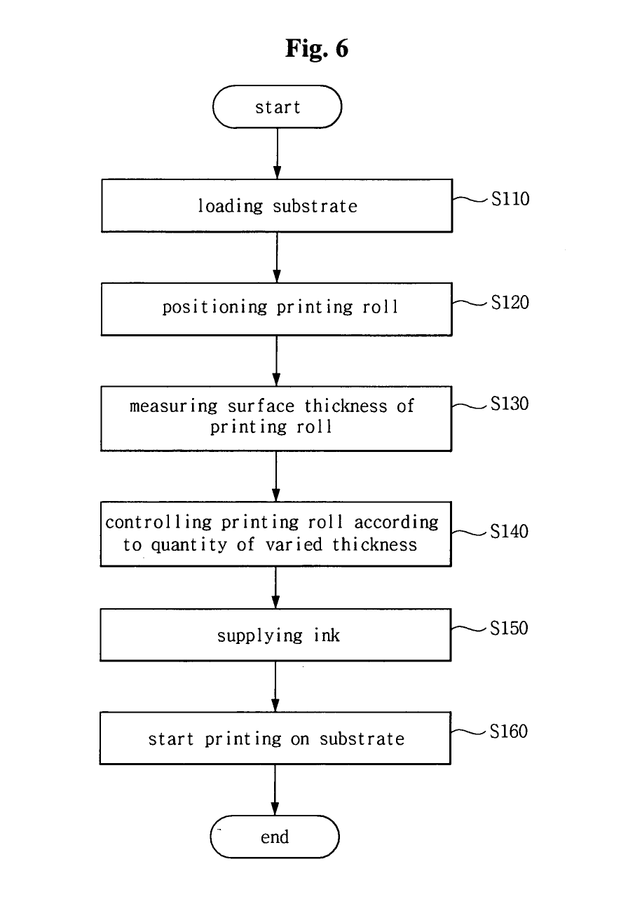

FIG. 6 is a flow chart for explaining a method of printing using the alignment layer printing apparatus in accordance with another embodiment of the present invention.

In the method of printing in accordance with the embodiment of the present invention, firstly, a substrate to be printed may be loaded on a movable stage S110. Here, the substrate may be a color filter substrate or array substrate constituting a liquid crystal display device.

Next, the movable stage may be moved in an up-and-down direction or left-and-right direction and put into the manufacturing process, and a printing roll may be positioned on the movable stage S120.

Then, the surface thickness of the printing roll may be measured by means of a displacement sensor S130.

In general, when a printing operation is continuously performed, ink applied on the surface of the printing roll may be gradually adsorbed into a rubber plate to invoke the increment of total radius of the printing roll and the rubber plate, which may be sensed in real time by means of the displacement sensor.

The displacement sensor may be a non-contact type, which measures the distance between the displacement sensor and the surface of the rubber plate by receiving light emitted onto the surface of the rubber plate. A variety of methods of measuring the distance may be applied according to a sensing method. For example, it is possible to measure the distance between the displacement sensor and the surface of the rubber plate by measuring the quantity of light reception by the displacement sensor or counting the time of light reception by the displacement sensor.

The measurement of the thickness of the rubber plate by means of the displacement sensor can be automatically implemented in real time by setting a predetermined period of time, and when necessary, can be manually implemented by a user's manipulation.

Afterwards, the operation of the printing roll may be controlled according to the thickness of the rubber plate based on the value measured by means of the displacement sensor S140.

When the thickness of the rubber plate is changed, the travel velocity VL, rotation velocity (or angular velocity) Vθ, and impression pressure of the printing roll are also changed, and thus may be different from preset operational parameters of the printing roll. This may be compensated for to control the operation of the printing roll.

For this purpose, the value measured by the displacement sensor may be converted into a thickness value, and the thickness value may be compared with the existing thickness of the rubber plate to detect a thickness change.

Then, the travel velocity, rotation velocity, and impression pressure of the printing roll are respectively compensated for according to the detected thickness change, thus readjusting the operation of the printing roll.

The compensation of the travel velocity, rotation velocity, and impression pressure of the printing roll may be performed by a method of calculation based on a stored equation.

Afterwards, ink may be supplied to the printing roll S150.

The ink may be an alignment solution for applying an alignment layer to be formed on a color filter substrate and an array substrate, and may be filled in great quantities in a supply tank located in the outside.

Thereafter, the printing roll may be driven under the compensated control to print ink onto the substrate S160.

A method of manufacturing a liquid crystal display is hereafter described in accordance with an embodiment of the present invention. An upper substrate or a lower substrate may be loaded on a stage and a printing roll may be positioned on the loaded substrate. A measurement of the printing roll may indicate a size change of the printing roll. The operation of the printing roll relative to the stage may be compensated according to the measurement of the printing roll. Ink may be supplied to the printing roll and the driving of the printing roll may occur under the compensated operation to print ink onto the loaded substrate. Both the upper substrate and the lower substrate may undergo the above described process.

In the method of manufacturing the liquid crystal display, the upper substrate and lower substrate may be attached and a liquid crystal layer may be formed therebetween. The formation may occur before or after attaching the upper and lower substrates.

Although the embodiment of the present invention has been described with reference to the attached drawings, it will be understood by those skilled in the art that the present invention can be implemented in other specific forms without changing the technical spirit or essential features of the present invention.

So to speak, although the embodiment of the present invention has been described with respect to an alignment layer printing apparatus used in the manufacturing process of a liquid crystal display device, the present invention is not limited thereto but a variety of technical fields for printing ink onto a substrate in a roll type may be applied.

The thus-configured alignment layer printing apparatus and method of printing using the same in accordance with the present invention can prevent a defect of a print pattern using a roll printing method by monitoring a change in the thickness of the rubber plate in real time and controlling the operation of the printing roll according to a thickness change of the printing roll.

Due to this, the printing accuracy of the alignment layer printing apparatus can be enhanced, and the reliability of the product can be enhanced.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of manufacturing a liquid crystal display, comprising:
loading an upper substrate or a lower substrate on a stage;
positioning a printing roll on the loaded substrate;
measuring the printing roll, the measurement being indicative of a size change of the printing roll;
compensating the operation of the printing roll relative to the stage according to the measurement of the printing roll;
supplying an alignment solution to the printing roll;
driving the printing roll under the compensated operation to print the alignment solution onto the loaded substrate;
attaching the upper substrate and the lower substrate; and
forming a liquid crystal layer between the upper substrate and the lower substrate.

2. The method of claim 1, wherein the step of measuring the printing roll includes measuring a surface thickness of the printing roll.

3. The method of claim 2, wherein the step of measuring a surface thickness includes providing a displacement sensor on the surface of the printing roll and measuring a distance between the displacement sensor and the surface of the printing roll.

4. The method of claim 1, wherein the step of measuring is performed at predetermined periods of time.

5. The method of claim 1, wherein the step of compensating the operation of the printing roll includes:
determining a size change of the printing roll from the measurement of the printing roll; and
compensating for the travel velocity, rotation velocity and impression pressure of the printing roll relative to the stage according to the determined size change.

6. A method of printing, comprising:
loading a substrate on a stage;
positioning a printing roll on the substrate;
measuring the printing roll, the measurement being indicative of a size change of the printing roll;
compensating the operation of the printing roll relative to the stage according to the measurement of the printing roll;
supplying ink to the printing roll; and
driving the printing roll under the compensated operation to print the ink onto the substrate.

7. The method of claim 6, wherein the step of measuring the printing roll includes measuring a surface thickness of the printing roll.

8. The method of claim 7, wherein the step of measuring a surface thickness includes providing a displacement sensor on the surface of the printing roll and measuring a distance between the displacement sensor and the surface of the printing roll.

9. The method of claim 6, wherein the step of measuring is performed at predetermined periods of time.

10. The method of claim 6, wherein the step of compensating the operation of the printing roll includes:
determining a size change of the printing roll from the measurement of the printing roll; and
compensating for the travel velocity, rotation velocity and impression pressure of the printing roll relative to the stage according to the determined size change.

11. The method of claim 6, wherein the ink includes an alignment solution for forming an alignment layer.

12. A printing apparatus for printing an alignment layer of a liquid crystal display, comprising:
a stage for loading a substrate thereon;
a printing roll positioned on the stage to transfer ink onto the substrate while rotating in one direction;
a displacement sensor for measuring a surface thickness of the printing roll; and
a controller for compensating the operation of the printing roll relative to the stage according to a value measured by the displacement sensor.

13. The printing apparatus of claim 12, wherein the displacement sensor is positioned on an upper side of the printing roll.

14. The printing apparatus of claim 12, wherein the displacement sensor is a non-contact displacement sensor.

15. The printing apparatus of claim 12, wherein the printing roll includes a rubber plate provided on the surface of the printing roll.

16. The alignment layer printing apparatus of claim 15, wherein the rubber plate includes a mask pattern formed so as to selectively print ink onto the substrate.

17. The printing apparatus of claim 12, wherein the controller determines a change in thickness of the printing roll based on the value measured by the displacement sensor, and compensates the operation of the printing roll according to the determined changed in thickness.

18. The printing apparatus of claim 12, wherein the controller includes:
a thickness converter for converting the value measured by the displacement sensor into a thickness value;
a comparator for comparing the surface thickness of the printing roll calculated by the thickness converter and the reference surface thickness of a printing roll to calculate a change in thickness; and
a compensator for compensating for the operation of the printing roll relative to the stage according to the change in thickness.

19. The alignment layer printing apparatus of claim 18, wherein the operation of the printing roll includes travel velocity, rotation velocity, and impression pressure of the printing roll.

20. The alignment layer printing apparatus of claim 12, wherein the ink includes an alignment solution for forming an alignment layer.

21. The alignment layer printing apparatus of claim 12, wherein the alignment layer printing apparatus includes:
a doctor roll for receiving a supply of ink; and
an anilox roll which rotates in engagement with the doctor roll and the surface of the printing roll so as to transfer the ink supplied from the doctor roll onto the surface of the printing roll.
